(19) United States
(12) Patent Application Publication
(10) Pub. No.: US 2005/0260119 A1
(43) Pub. Date: Nov. 24, 2005

(54) Carbon nanopipettes methods of making and applications

(76) Inventors: Mahendra Kumar Sunkara, Louisville, KY (US); Radhika C. Mani, Louisville, KY (US)

Correspondence Address: David W. Carrithers;CARRITHERS LAW OFFICE, PLLC, One Paragon Centre, 6060 Dutchman's Lane, Suite 140, Louisville, KY, 40205, US

(21) Appl. No.: 10/936,889

(22) Filed: Sep. 9, 2004

Related U.S. Application Data
(60) Provisional application No. 60/501,533, filed on Sep. 9, 2003.

(51) Int. Cl. C01B 31/00

(52) U.S. Cl. 423/445 R

(57) ABSTRACT

A new morphological manifestation of carbon based nanostructures in the form of tapered whiskers with uniform 1-3 nm hollowness. The base of the whiskers is in the sub-micron scale, tapering uniformly to form a pointed tip in the form of a pipette. The hollow nanopipettes have a shell containing helical graphitic sheets.

This application is part of a government project. The research leading to this invention was supported NSF through Contract/Grant No. 9876259. The United States Government retains certain rights in this invention. This application claims priority from U.S. Provisional Application Ser. No. 60/501,533 file don Sep. 9, 2003.

### BACKGROUND OF THE INVENTION

1. Field of the Invention

This invention relates generally to nanostructures and more particularly to a method of making carbon nanopipettes, and the uses for same. The instant invention describes the synthesis of the novel nanostructures, their use as AFM tips, the ability to transfer them to different substrates, applicability to making patch devices for drug delivery, and the ability to transfer them into ink-jet print heads for various applications.

2. Description of the Prior Art

Bando et al. as set forth in Appl. Phys. Lett. 81, 3966 (2002) uses a thermal evaporation of gallium oxide and carbon to synthesize straight carbon nano tubes. In a related technical article Pan et al. in Appl. Phys. Lett 2003, 82, 1947 synthesized carbon nano tubes by vaporizing gallium nitride powder in the presence of acetylene.

The teachings of the above-noted prior art demonstrated an uncontrolled growth process yielding only straight tubes with small inner diameters of only about 30-200 nm. Control of the morphology of the carbon nano tubes was not taught by the references.

### SUMMARY OF THE INVENTION

The present invention comprises a technique to synthesize and control the morphology of tubular carbon nano structures. Different morphologies of tubular carbon such as tubes, cones, nozzles, funnels, and multijunctioned tubes, can be synthesized reliably. The technique is based on the wetting behavior of gallium with carbon in different gas phase growth environments.

The carbon nanopipettes of the present invention have use as trans ocular drug delivery, in ink jet print heads, as AFM/NSOM/STM tips, localized electrochemical probe and field emission tips, nano fluid delivery systems, absorption and percolation medium, electronic devices such as junction diodes made of multi-junctioned tubular structures, lithium exchange medium in batteries, ink delivery systems for printer cartridges, and hollow funnels or nano-crucibles for metal alloy production permitting the containment and handling of very small amounts of material such as for combinatorial synthesis, and for micro-reactors for combinatorial synthesis.

The carbon tubular structures of the present invention provide nanopipettes which form rigid structures. They have a base of about 1 micron and a tip <10 nm. They have a through passage open at both ends. They may be formed so that the passage is of constant diameter throughout. This makes it easy to deliver fluids such as chemicals or drugs through them.

It is an object of the present invention to form nano tubular structures wherein a large, well aligned array of these nanopipettes can be grown.

It is an object of the present invention to form nano tubular structures wherein the length can be modified by the time used in their growth, from 0.5 microns to about 100 microns.

It is an object of the present invention to form nano tubular structures which can be transferred to most any substrate depending upon the application, i.e., when used to deliver a drug to the eye without normally causing any trauma to the eye.

It is an object of the present invention to form nano tubular structures whereby the morphology can be controlled and fine tuned as needed.

It is an object of the present invention to form nano tubular structures whereby larger inner diameter tubes can be produced with control over the inner diameters.

It is an object of the present invention to form nano tubular structures wherein a large number can be packed into an inkjet head and thereby provide an improved quality of print.

It is an object of the present invention to form nano tubular structures usable as AFM/STM/NSOM tips having the advantages that they are conducting, rigid, and can be formed having tips as small as a few nano microns.

It is an object of the present invention to provide a method of synthesizing different nano tubular morphologies in a controlled fashion, like cones, nozzles, straight tube, funnels, and multi-junctioned tubular structures.

It is an object of the present invention to control the diameter of the interior tubular structure.

It is an object of the present invention to produce nano tubular structures having a constant wall thickness of from about 15 to about 30 nm with the inner diameter comprising up to several microns providing large diameter carbon tubes.

It is an object of the present invention to prepare nano tubular structures that are open ended on both ends so that they are directly applicable to nano-micro-fluidics.

It is an object of the present invention to form nano tubular structures which can be easily removed from the growth substrate onto any desire platform.

It is an object of the present invention to form nano tubular structures which can be grown on very large areas, as great or greater than a two inch square area.

It is an object of the present invention to form nano tubular structures having open ended and hollow Y-junctions with seamless joining at the junction cab making them directly applicable to nano/micro fluidics.

It is an object of the present invention to form nano tubular structures whereby no special templating is necessary for producing Y-junctions and the synthesized Y-junction are defect free at the junction.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 schematically illustrates a system for growing nanopipettes that includes platinum wires projecting upwardly from a support;

FIG. 2 is a scanning electron microscope (SEM) image of a region away from the tip that is covered by microcrystalline diamond film with a crop of nanostructures growing on them;

FIG. 3a, 3b are SEM images showing the whiskers emerging out of the microcrystalline diamond deposit at the regions away from the tip of the platinum wire;

FIGS. 4a, 4b are high-resolution SEM images of the whiskers in which FIG. 4b shows one whisker with a wrap up sheet;

FIG. 5 is a Transmission Electron Microscope (TEM) bright field image of the whiskers;

FIG. 6 is a TEM dark field image of a single pipette and the inset shows the energy filtered TEM high lighting the sp2 core loss;

FIG. 7 is a view showing an electron diffraction of a single nanopipette;

FIGS. 8a, 8b, and 8c are views in which 8a illustrates a conical structure with a central nanotube, 8b the aspect ratio of the conical structure increasing giving rise to nanopipes 8c;

FIG. 9 diagrammatically illustrates the processing steps that are required for fabrication of a drug delivery device (a patch) containing nanopipettes

FIG. 10 illustrate in cross-section an eye ball in which the one on the right has nanopipettes inserted therein for delivery of a drug into the eye and

FIG. 11 is a diagrammatic illustration of nanopipettes in an ink jet print head.

### DESCRIPTION OF THE PREFERRED EMBODIMENT

Morphological manifestation of carbon nanotubes have been synthesized in the shape of nano tubular structures forming nanonpipettes, with an outer conical shape and an inner hollow core. The structures were synthesized in a microwave plasma assisted chemical vapor deposition (MWCVD) ASTeX model 5010. Several platinum(Pt) wires 10 (Alfa Aesar®. 0.01 in. dia, 99.9%) were cleaned with acetone. The platinum wire was seeded by mechanical scratching in a paste of diamond powder (GE, 0-2 micron particle size) in acetone. This was followed by ultrasonication in acetone. Boron nitride substrates in the form of plates 20 were drilled with holes about 0.03 in. diameter. The seeded Pt wires were placed vertically in the holes of the boron nitride plate and this plate was placed on a graphite substrate stage 30 A few pieces of Boron 40 were placed around this arrangement (please see FIG. 1). Instead of a boron nitride plate, experiments were conducted using a hemispherical block of graphite, with about 21 holes drilled in it.

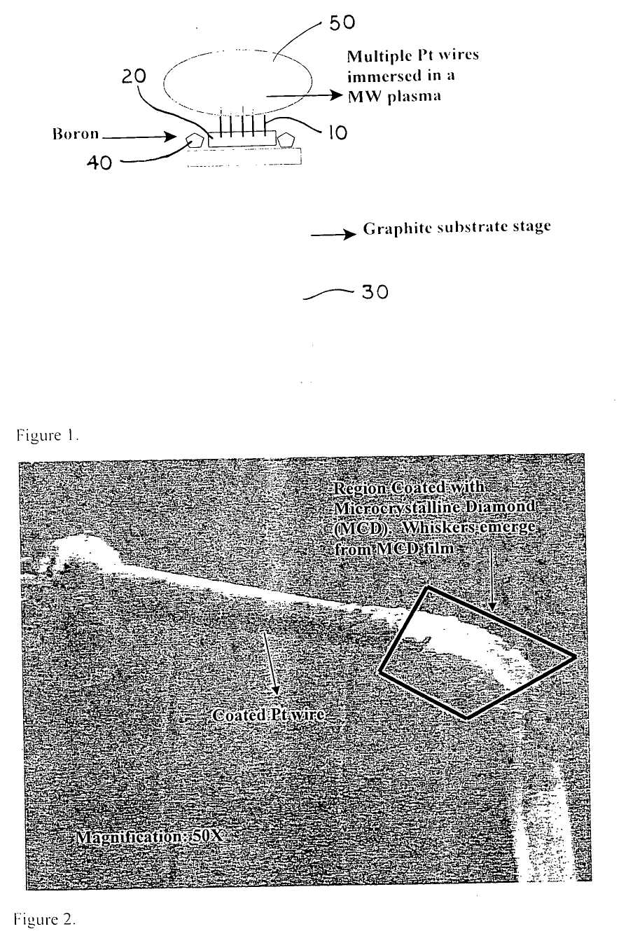

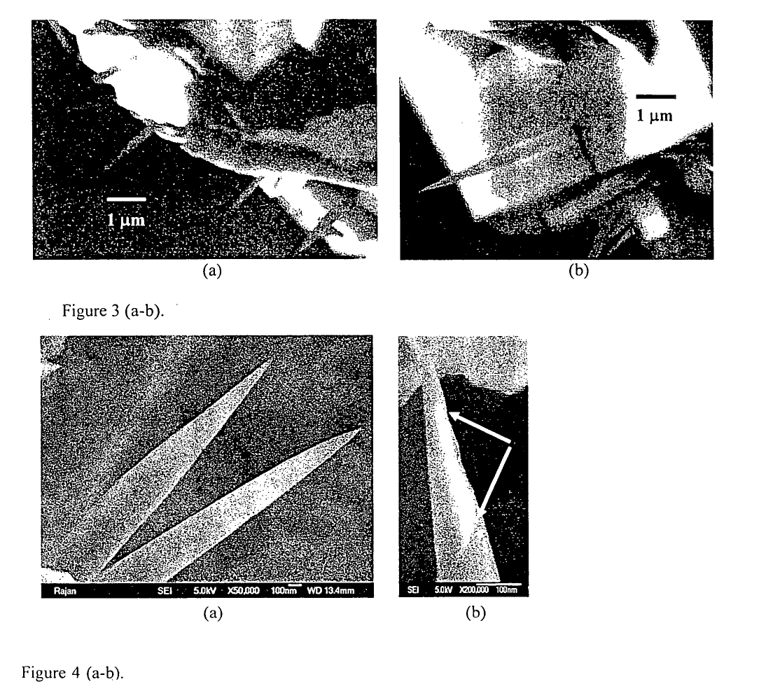

The platinum wire was exposed to microwave generated hydrogen plasma environment 50 containing methane (1-2%) amounts for 24 hrs. About 1 cm of the platinum wire was immersed in the ball shaped plasma. The substrate temperature was measured using an optical pyrometer to be approximately 950° C. for microwave power of 1100 W. 50 torr pressure and 2 sccm methane in 200 sccm of hydrogen in the feed gas. After a typical growth experiment, the tip of the wire was coated with a dense bulb-shaped deposit, while a region 60 away from the tip was covered by microcrystalline diamond film, with a crop of nanostructures growing on them (please see FIG. 2). The Pt wire was imaged using a scanning electron microscope (SEM) FIGS. 3(a-b) show whiskers 80 emerging out of the microcrystalline diamond deposit at regions away from the tip of the platinum wire. FIG. 4(a-b) shows the high-resolution SEM images of the whiskers. These SEM images indicate external faceting of the nanostructures. FIG. 4(b) shows one whisker with a wrapped up sheet 90.

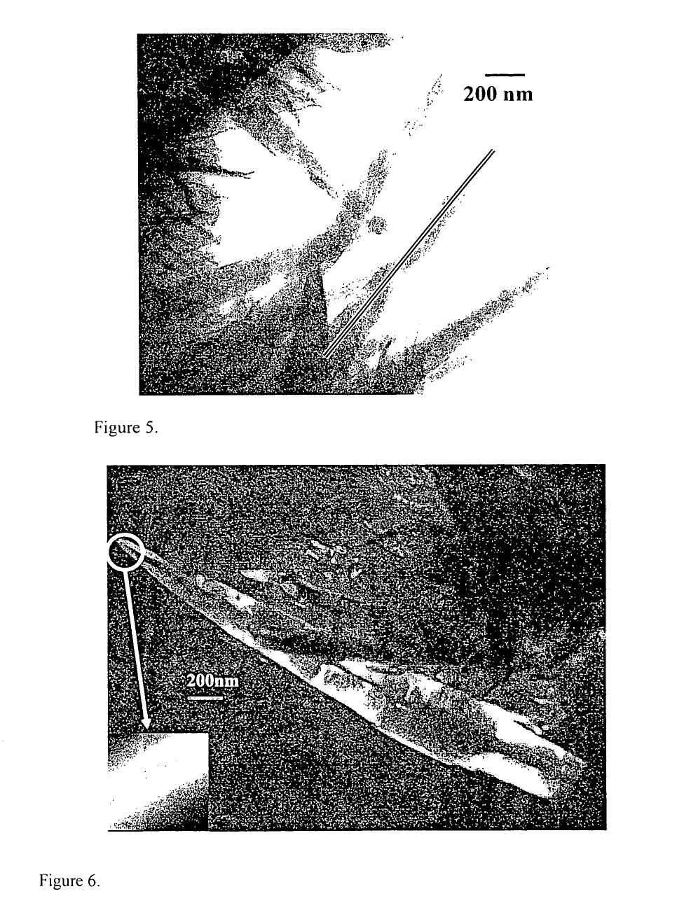

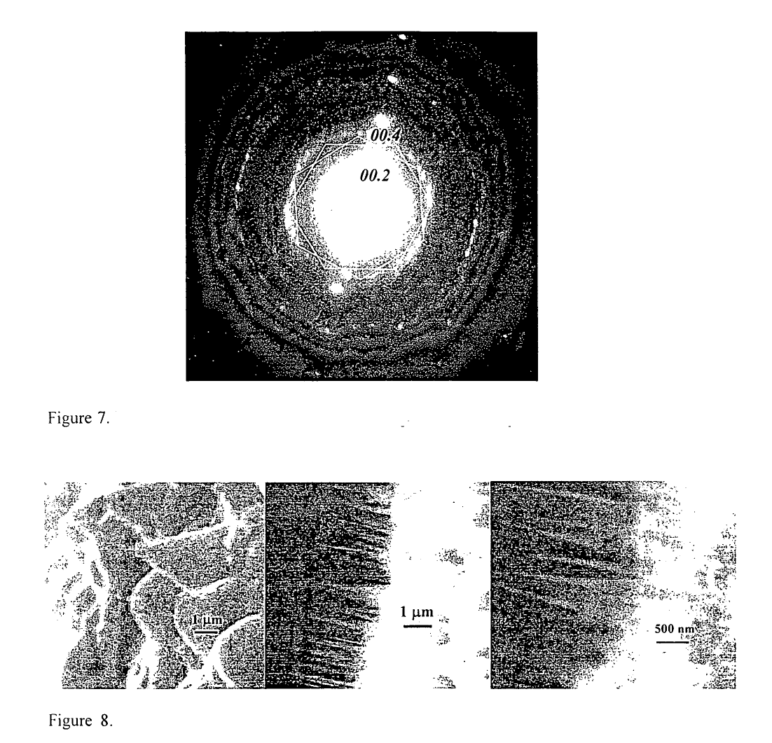

In order to characterize these whiskers, a Transmission electron microscope was used at Rensselaer Polytechnic Institute identified as JEOL 2010 Model. The bright field image of the whiskers is shown in FIG. 5. This image clearly illustrates the constant hollow core 81 of the whisker. The dark field image in FIG. 6 highlights this structure even further showing the hollow core running down the entire length of a whisker. At the tip 82 of the whisker 80, where the thickness permitted a reasonable signal, an energy-filtered image using the sp² core loss peak clearly illuminated the specimen, (FIG. 6, inset). The dark region running down the axis of the whisker corresponds to the hollow core, which evidently does not contribute to any signal (in this case inelastically scattered core loss electrons). Based on the energy loss images, the walls of the whisker at least in the tip region appeared to be graphitic in nature. Basic basal plane lattice images confirmed this graphitic structure. Diffraction patterns from thicker regions of the whisker (FIG. 7) however exhibited characteristic features of possible helical morphologies. The pitch angle associated with this type of structure can vary (in the case of region of the whisker sampled shown in FIG. 7, this angle is 9°) giving rise to a more complex morphology. Hence these nanopipettes are conical graphitic structures with an inner constant diameter hollow core of about 4-10 nm, and a shell made up of helical sheets of graphite.

A platinum wire, coated with 20 mm of microcrystalline diamond, was electroplated with about 50 nm of platinum using an electroplating bath. This substrate was now placed in the plasma the same way as in FIG. 1 for shorter time scales, one hour or less. The results of this experiment are shown in FIG. 8(a-c). As shown in this figure, there is a continuous gradient of one-dimensional structures along the wire. The region close to the tip of the wire has a conical structure, whose core contains a multi-walled (or single-walled) carbon nanotube (FIG. 8(a)). The nanotube is surrounded by graphite deposit. As we move away from the tip of the substrate, there is a competition between the etching and growth of crystalline phase (sp2) of carbon. Hence the central nanotube remains, while the surrounding graphite material also grows rapidly. Thus, a short distance away from the conical structures, we obtain structures with a higher aspect ratio (shown in FIG. 8(b)) and further away we obtain nanopipettes (FIG. 8(c)). The density of these nanopipettes gradually reduces as we move to the end of the substrate. Hence, depending on their position in the plasma, we can control their aspect ratios and densities.

In some cases, the tubular structures may be at least partially filled with gallium; however, the gallium can be riven away by simple heating in a vacuum up to 1000° C.

These nanopipettes can be directly synthesized on AFM heads as probes for surface analysis. They are rigid (having a base of 1 mm), conducting, and the tips being very small, can precisely scan the surface.

### Application in Trans Ocular Drug Delivery

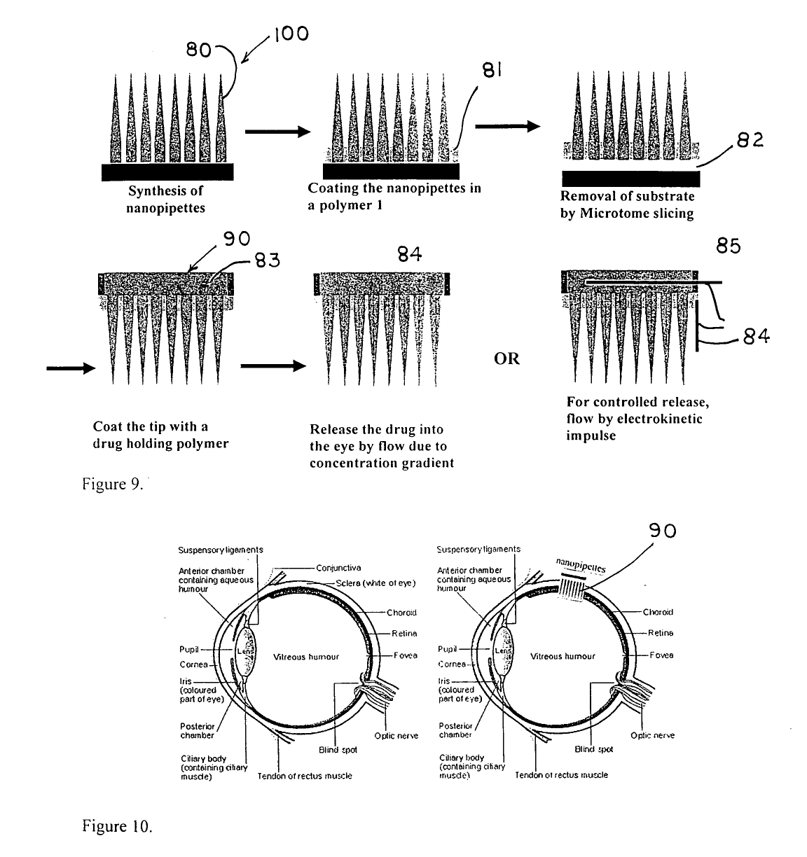

FIG. 9 schematically shows the post-processing steps that are required for fabrication of a patch 90 (the drug delivery device) containing nanopipettes (sub-micron scale needles with few nm hollowness). The sequence involves polymer encapsulation 81 of the nanopipettes, dicing 82 this assembly parallel to the substrate, and attachment of the nanopipettes to another polymer sheet 83 for handling. This polymer sheet is capable of holding the drug to be delivered to the eye. This method of transfer of nanopipette array is novel. Drug delivery testing, first in-vitro and then in-vivo will be carried out. A simple concept is shown where one can convert this patch into device for controlled release application using nanopipette array as one electrode 84 and another electrode 85 in drug formulation. The schematic of insertion of the patch into the eye is shown in FIG. 10. The nanopipettes proposed in this work could offer advantages: the internal hollow channels of the carbon nanopipettes could enhance drug delivery to target locations; the texture and smoothness of the outer surface of these nanostructures should be relatively better than the micro-fabricated needles.

### Application in Inkjet Printheads

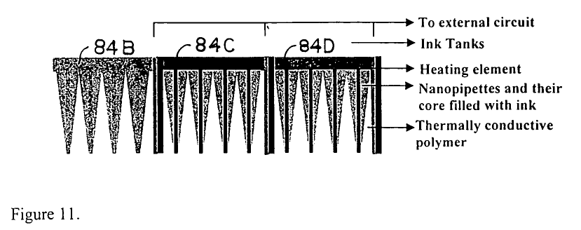

Applicants have grown aligned arrays with high densities (^{˜}10⁷/cm²). The nanopipettes 80 can be embedded into a heat conductive polymer 100, diced by a micro tone, and ink tanks 101 can be microfabricated at the top of the array containing different colors e.g. red, blue, green as viewed left to right in FIG. 11. A heating element 102 can be coated adjacent to each array assembly. The heating element transfers its heat to the ink-filled nanopipette through the heat conductive polymer. By the principle of ink-jet, a bubble is produced by the expansion of the ink, which makes the ink flow out from the pipette.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented hereinabove. Rather, what is intended to be covered is within the spirit and scope of the appended claims.

1. We claim a method of synthesizing and controlling the internal diameters, conical angles, and morphology of tubular carbon nano/micro structures, comprising the steps of:
selecting a low melting metal;
selecting a substrate;
selecting a gas;
depositing said low melting metal on said substrate in a thin film;
depositing a molybdenum powder on said thin film of said low melting metal;
producing a gas phase excitation by inserting said substrate having a thin film of a low melting metal containing at least some molybdenum powder thereon is a microwave plasma reactor in methane gas under pressure for a selected period of time at a selected temperature and selected pressure; and
forming a tubular nanostructure.
